(19) United States
(12) Patent Application Publication
(10) Pub. No.: US 2010/0058767 A1
(43) Pub. Date: Mar. 11, 2010

(54) SWIRL ANGLE OF SECONDARY FUEL NOZZLE FOR TURBOMACHINE COMBUSTOR

(75) Inventors: Derrick Walter Simons, Greer, SC (US); Alberto Jose Negroni, Simpsonville, SC (US); Larry Lou Thomas, Flat Rock, NC (US); Jeffrey Scott LeBegue, Simpsonville, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/205,503

(22) Filed: Sep. 5, 2008

(51) Int. Cl. F02C 1/00

(52) U.S. Cl. 60/748

(57) ABSTRACT

A combustor includes a primary combustion chamber and a secondary combustion chamber, one or more primary nozzles disposed in the primary combustion chamber and providing fuel to the primary combustion chamber, a centerbody assembly, a venturi disposed downstream of the centerbody assembly, and a secondary fuel nozzle housed within the centerbody assembly and extending towards the venturi and providing fuel to the secondary combustion chamber. The secondary fuel nozzle includes a fuel passage and an air passage, and a swirler positioned around the fuel passage and having one or more vanes projecting radially within the air passage, each vane having a trailing edge arranged at a swirl angle relative to a longitudinal axis of the secondary fuel nozzle, the swirl angle is greater than 45°.

### BACKGROUND OF THE INVENTION

This invention relates to turbomachines. More particularly, this invention relates to a secondary fuel nozzle of a dry low NOx (“DLN”) combustor for a turbomachine having an improved swirl angle.

A conventional dry low NOx DLN combustor includes a fuel injection system having primary nozzles and a secondary fuel nozzle, a liner, a venturi and a cap/centerbody assembly. In the system, a fuel and air mixture travels through an annular passage bound by the secondary fuel nozzle and an outer burner tube attached to the liner. A bulk component of flow velocity, (i.e., swirl) is imparted on the mixture prior to being burned in a downstream combustion chamber of the annular passage. In the conventional low NOx DLN combustor, the reduction of NOx emission is sensitive to bulk swirl characteristics of the secondary fuel nozzle. That is, the swirl angle of reacting combustion gases is a significant parameter in the stability and emissions of the combustor. In the conventional combustor, the swirl angle is typically less than or equal to approximately 45°.

### BRIEF DESCRIPTION OF THE INVENTION

An exemplary embodiment of the present invention provides a combustor includes a primary combustion chamber and a secondary combustion chamber, one or more primary nozzles disposed in the primary combustion chamber and providing fuel to the primary combustion chamber, a centerbody assembly, a venturi disposed downstream of the centerbody assembly, and a secondary fuel nozzle housed within the centerbody assembly and extending towards the venturi and providing fuel to the secondary combustion chamber. The secondary fuel nozzle includes a fuel passage and an air passage, and a swirler positioned around the fuel passage and having one or more vanes projecting radially within the air passage, each vane having a trailing edge arranged at a swirl angle relative to a longitudinal axis of the secondary fuel nozzle, wherein the swirl angle is greater than 45°.

Another exemplary embodiment of the present invention provides a nozzle for a combustor. The nozzle includes a nozzle body housed within a centerbody assembly of the combustor, the nozzle body including a fuel passage, and an air passage surrounding the nozzle body, and a swirler located radially between the fuel passage and the air passage, the swirler including one or more vanes circumferentially spaced about the fuel passage, each vane having a trailing edge arranged at an angle of greater than 45° relative to a longitudinal axis of the nozzle body.

Another exemplary embodiment of the present invention provides a method for reducing NOx in a combustor. The method includes providing a nozzle in a centerbody assembly of the combustor having a fuel passage and a air passage, and a swirler in the nozzle supporting the fuel passage and having one or more vanes shaped to create a swirl angle relative to a longitudinal axis of the nozzle, delivering discharge air from a compressor to the air passage and fuel to the fuel passage, and mixing, via the swirler, the discharge air with fuel, and swirling the mixture at a swirl angle greater than 45°.

Another exemplary embodiment of the present invention provides a turbomachine that includes a compressor and at least one combustor configured to receiving incoming fuel and discharge air from the compressor. The combustor includes a primary combustion chamber and a secondary combustion chamber, one or more primary nozzles disposed in the primary combustion chamber and providing fuel to the primary combustion chamber, a centerbody assembly, a venturi disposed downstream of the centerbody assembly, a secondary fuel nozzle housed within the centerbody assembly and extending towards the venturi and providing fuel to the secondary combustion chamber. The secondary fuel nozzle includes a fuel passage and an air passage, and a swirler positioned around the fuel passage and having one or more vanes projecting radially within the air passage, each vane having a trailing edge arranged at a swirl angle relative to a longitudinal axis of the secondary fuel nozzle, the swirler configured to swirl a mixture of the discharge air in the air passage and fuel in the fuel passage at a swirl angle greater than 45°. The turbomachine further includes at least one turbine operatively connected to the combustor.

Additional features and advantages are realized through the techniques of exemplary embodiments of the invention. Other embodiments and aspects of the invention are described in detail herein and are considered a part of the claimed invention. For a better understanding of the invention with advantages and features thereof, refer to the description and to the drawings.

### BRIEF DESCRIPTION OF THE DRAWINGS

FIG. 1 is a partial side sectional view of a combustor that can be implemented within embodiments of the present invention.

FIG. 2 is a side sectional view of a secondary fuel nozzle of the combustor that can be implemented within embodiments of the present invention.

FIG. 3 is view of a swirler that can be implemented within embodiments of the present invention.

FIG. 4 is a view of one vane of the plurality of vanes of the swirler shown in FIG. 3 that can be implemented within embodiments of the present invention.

### DETAILED DESCRIPTION OF THE INVENTION

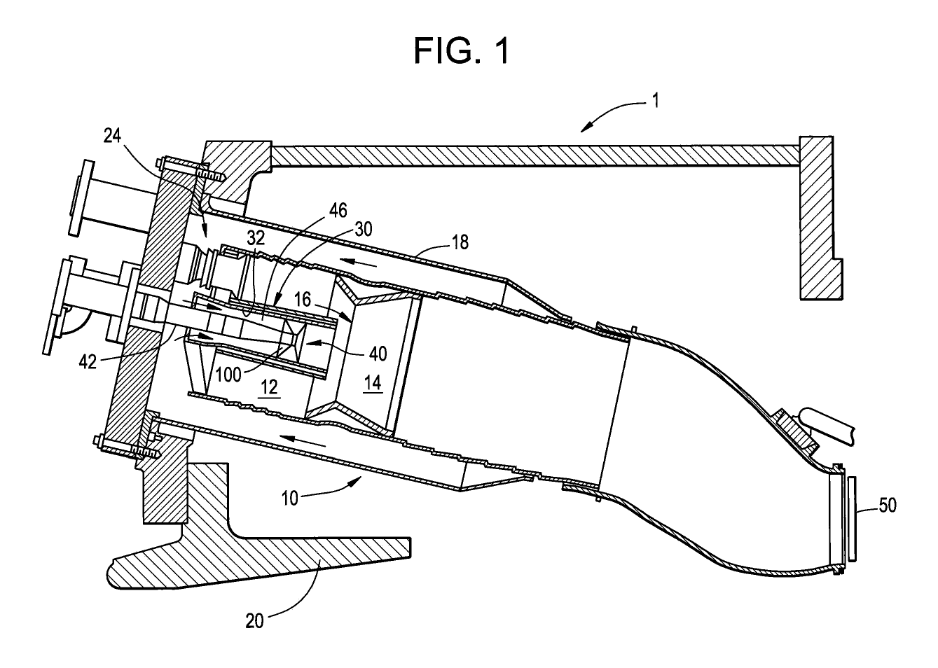

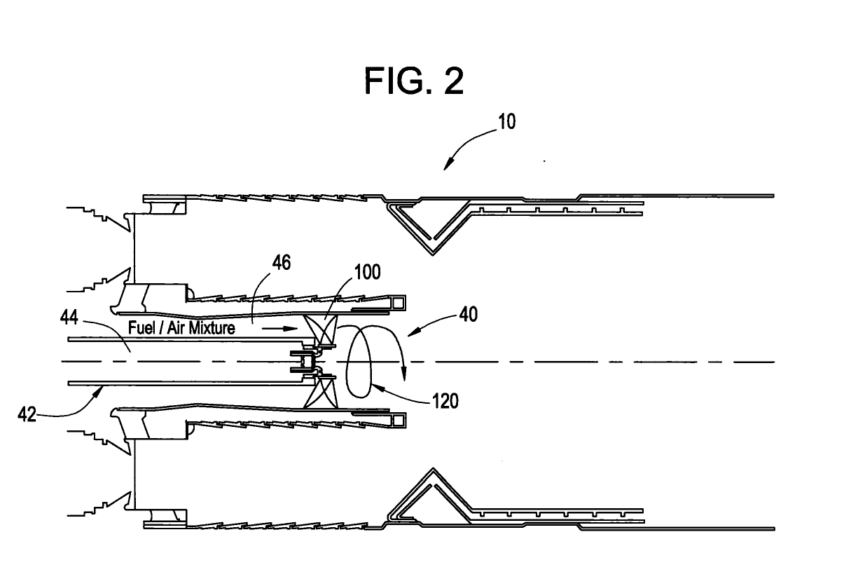

Referring to FIG. 1, a combustor 10 for a turbomachine 1 is provided in accordance with an embodiment of the present invention. The turbomachine 1 includes at least one combustor 10, a compressor 20 and at least one turbine represented by a single blade 50 operatively connected to the combustor 10. The combustor 10 includes a primary combustion chamber 12 and a secondary combustion chamber 14 separated by a venturi 16. The combustor 10 is surrounded by a flow sleeve 18 that guides discharge air (indicated by arrows) from the compressor 20 to the combustor 10. The combustor 10 further includes one or more primary nozzles 24, which deliver fuel to the primary combustion chamber 12 and a secondary fuel nozzle 40, which delivers fuel to the secondary combustion chamber 14. Although only one primary nozzle is shown in FIG. 1, the combustor 10 may include more primary nozzles 24. Fuel is delivered to the secondary fuel nozzle 40 via a fuel line (not shown). As shown in FIG. 1, the secondary fuel nozzle 40 is housed in a centerbody assembly 30 and extends through a liner 32 towards the venturi 16. The venturi 16 is disposed downstream of the centerbody assembly 30. The secondary fuel nozzle 40 includes a nozzle body 42, a fuel passage 44 (as depicted in FIG. 2) formed in the nozzle body 42 and an air passage 46 surrounding the nozzle body 42. A swirler 100 is positioned around the fuel passage 44 and includes one or more vanes 105 projecting radially within the air passage 46. That is, the swirler 100 is located radially between the fuel passage 44 and the air passage 46. Additional details regarding the swirler 100 will be described below with reference to FIGS. 2 through 4. The swirler 100 mixes discharge air (indicated by arrows) traveling through the liner 32 with fuel from the secondary fuel nozzle 40.

FIG. 2 illustrates the secondary fuel nozzle 40 of the combustor 10 that can be implemented within embodiments of the present invention. As shown in FIG. 2, the swirler 100 receives a fuel/air mixture and swirls the fuel/air mixture at a swirl angle greater than 45°. The fuel/air mixture is swirled in a swirling flow-field in a flame zone (as indicated by the arrow 120) as shown in FIG. 2, before it is burned downstream in the secondary combustion chamber 14. According to another embodiment, the swirl angle is in a range from greater than 45° to about 50°. Alternatively, according to another embodiment, the swirl angle is in a range from greater than 45° to about 60°. In addition, according to yet another embodiment, the swirl angle is in a range from greater than 45° to about 70°.

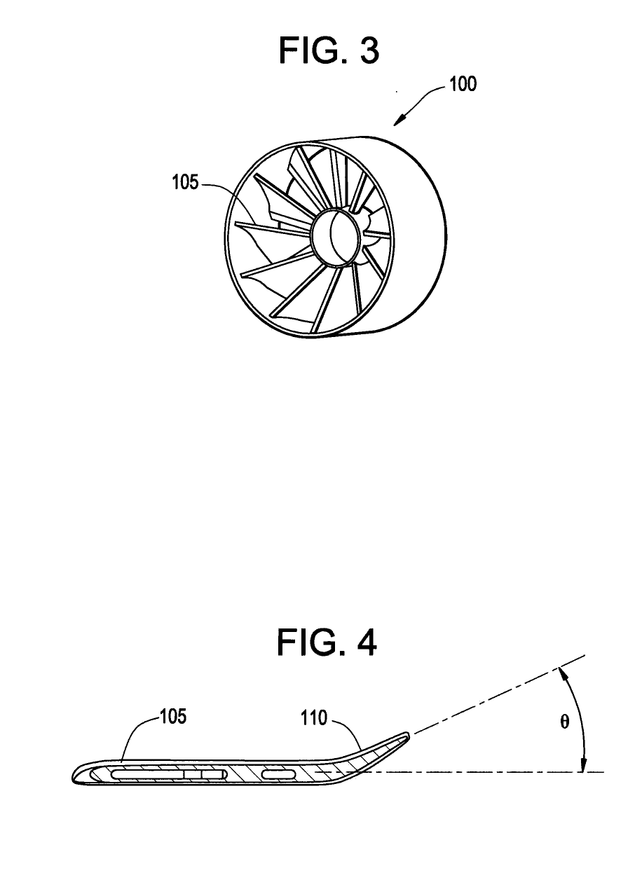

As shown in FIG. 3, according to one embodiment, the swirler 100 includes an array of vanes 105 that impacts the swirl of the fuel/air mixture flowing through the vanes 105. The plurality of vanes 105 are circumferentially spaced about the fuel passage 44.

FIG. 4 illustrates a vane of the plurality of vanes 105 of the swirler 100 as shown in FIG. 3 that can be implemented within embodiments of the present invention. As shown in FIG. 4, each vane 105 includes a trailing edge 110 arranged at an angle θ relative to a longitudinal axis of the secondary fuel nozzle 40. According to one embodiment, the angle θ is of greater than 45°. In accordance with another exemplary embodiment of the present invention, the angle θ is in a range from greater than 45° to about 50°. In yet another exemplary embodiment, the angle θ is in a range from greater than 45° to about 60°. In yet still another embodiment, the angle θ is in a range from greater than 45° to about 70°.

According to an embodiment of the present invention, by increasing the angle of the swirler of the secondary fuel nozzle to greater than 45°, the present invention provides the advantage of reducing NOx emissions while operating the combustor.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A combustor comprising:
a primary combustion chamber and a secondary combustion chamber;
one or more primary nozzles disposed in the primary combustion chamber and providing fuel to the primary combustion chamber;
a centerbody assembly;
a venturi disposed downstream of the centerbody assembly; and
a secondary fuel nozzle housed within the centerbody assembly and extending towards the venturi and providing fuel to the secondary combustion chamber, the secondary fuel nozzle comprising:
a fuel passage and an air passage, and
a swirler positioned around the fuel passage and having one or more vanes projecting radially within the air passage, each vane having a trailing edge arranged at a swirl angle relative to a longitudinal axis of the secondary nozzle, wherein the swirl angle is greater than 45°.

2. The combustor of claim 1, wherein the swirl angle is in a range from greater than 45° to about 50°.

3. The combustor of claim 1, wherein the swirl angle is in a range from greater than 45° to about 60°.

4. The combustor of claim 1, wherein the swirl angle is in a range from greater than 45° to about 70°.

5. A nozzle for a combustor, comprising:
a nozzle body housed within a centerbody assembly of the combustor, the nozzle body including a fuel passage, and an air passage surrounding the nozzle body; and
a swirler located radially between the fuel passage and the air passage, the swirler including one or more vanes circumferentially spaced about the fuel passage, each vane having a trailing edge arranged at an angle of greater than 45° relative to a longitudinal axis of the nozzle body.

6. The nozzle of claim 5, wherein the angle is in a range from greater than 45° to about 50°.

7. The nozzle of claim 5, wherein the angle is in a range from greater than 45° to about 60°.

8. The nozzle of claim 5, wherein the angle is in a range from greater than 45° to about 70°.

9. A method for reducing NOx in a combustor, the method comprising:
providing a nozzle in a centerbody assembly of the combustor having a fuel passage and a air passage, and a swirler in the nozzle supporting the fuel passage and having one or more vanes shaped to create a swirl angle relative to a longitudinal axis of the nozzle;
delivering discharge air from a compressor to the air passage and fuel to the fuel passage; and
mixing, via the swirler, the discharge air with fuel, and swirling the mixture at a swirl angle greater than 45°.

10. The method of claim 9, wherein the swirl angle is in a range from greater than 45° to about 50°.

11. The method of claim 9, wherein the swirl angle is in a range from greater than 45° to about 60°.

12. The method of claim 9, wherein the swirl angle is in a range from greater than 45° to about 70°.

13. A turbomachine comprising:
a compressor;
at least one combustor configured to receiving incoming fuel and discharge air from the compressor, the combustor comprising:
a primary combustion chamber and a secondary combustion chamber,
one or more primary nozzles disposed in the primary combustion chamber and providing fuel to the primary combustion chamber,
a centerbody assembly,
a venturi disposed downstream of the centerbody assembly, and
a secondary fuel nozzle housed within the centerbody assembly and extending towards the venturi and providing fuel to the secondary combustion chamber, the secondary fuel nozzle comprising:
a fuel passage and an air passage, and
a swirler positioned around the fuel passage and having one or more vanes projecting radially within the air passage, each vane having a trailing edge arranged at a swirl angle relative to a longitudinal axis of the secondary fuel nozzle, the swirler configured to swirl a mixture of the discharge air in the air passage and fuel in the fuel passage at a swirl angle greater than 45°; and
at least one turbine operatively connected to the combustor.

14. The turbomachine of claim 13, wherein the swirl angle is in a range from greater than 45° to about 50°.

15. The turbomachine of claim 13, wherein the swirl angle is in a range from greater than 45° to about 60°.

16. The turbomachine of claim 13, wherein the swirl angle is in a range from greater than 45° to about 70°.
